(19) United States
(12) Patent Application Publication
(10) Pub. No.: US 2006/0180185 A1
(43) Pub. Date: Aug. 17, 2006

(54) Dishwasher, and screen filter and pump lower for the same

(75) Inventors: Hae Deog Jeong, Changwon-si (KR); Byung Hwan Ahn, Gimhae-si (KR); Hung Myong Cho, Gimhae-si (KR); Sang Woo Woo, Changwon-si (KR); Jong Chul Bang, Changwon-si (KR)

Correspondence Address: MCKENNA LONG & ALDRIDGE LLP, 1900 K STREET, NW, WASHINGTON, DC, 20006, US

(73) Assignee: LG ELECTRONICS, INC., Youngsungpo-gu (KR)

(21) Appl. No.: 11/337,799

(22) Filed: Jan. 24, 2006

(30) Foreign Application Priority Data
Jan. 25, 2005 (KR) 10-2005-006638

(51) Int. Cl. B08B 3/00

(52) U.S. Cl. 134/58 D; 134/110

(57) ABSTRACT

A dishwasher, and a screen filter and a pump lower unit of the dishwasher are provided. The dishwasher includes the pump lower unit and the screen filter, a mounting protrusion and an insert hole, and a mounting knob. The screen filter is installed on the pump lower unit for removing impurities from wash liquid. The mounting protrusion and the insert hole are for aligning the screen filter with the pump lower unit. The mounting knob is for coupling a fastening member to fasten the screen filter to the pump lower unit.

### BACKGROUND OF THE INVENTION

1. Field of the Invention

The present invention relates to a dishwasher, and more particularly, to a screen filter and pump lower unit of the dishwasher.

2. Description of the Related Art

A dishwasher is a home appliance that sprays high-pressure wash liquid through spray nozzles to wash and remove food residue left on surfaces of dishes. Specifically, a dishwasher includes a tub forming a wash compartment, and a sump installed at the bottom of the tub for storing wash liquid. Installed inside the sump is a wash pump that pumps wash liquid to the spray nozzles. The wash liquid pumped to the spray nozzles is discharged under high pressure through spray holes at the ends of the nozzles. The high-pressure wash liquid spray collides with the surfaces of dishes, so that food residue and other impurities on the dishes fall to the floor of the tub.

A sump installed in a dishwasher according to the related art has a screen filter coupled within the sump that filters impurities from wash liquid in a primary filtering stage.

To install a screen filter in the related art, a plurality of fastening members are needed, which couple and detach the screen filter.

However, in the above sump according to the related art, each of the fastening members must be individually fastened or disassembled in order to couple or remove the screen filter.

Additionally, in order to precisely position and install the screen filter, a delicate assembling process that consumes a lot of time is required.

### SUMMARY OF THE INVENTION

Accordingly, the present invention is directed to a dishwasher that substantially obviates one or more problems due to limitations and disadvantages of the related art.

An object of the present invention is to provide a dishwasher and a screen filter and a pump lower unit thereof that simplifies a fastening process of the screen filter, and also reduces the number of fastening components and the time that the fastening process takes.

Another object of the present invention is to provide a dishwasher and a screen filter and pump lower unit thereof that installs the screen filter in a precise position while simplifying the assembly process at the same time.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided dishwasher including: a pump lower unit; a screen filter installed on the pump lower unit for removing impurities from wash liquid; a mounting protrusion and an insert hole for aligning the screen filter with the pump lower unit; and a mounting knob for coupling a fastening member for fastening the screen filter to the pump lower unit.

In another aspect of the present invention, there is provided a screen filter installed on a pump lower unit of a dishwasher for removing impurities from wash liquid, the screen filter including: an aligning hole formed in a predetermined portion of the pump lower unit for aligning the screen filter on the pump lower unit; and a through-hole for fastening the screen filter to the pump lower unit by means of a fastening member passing through the through-hole.

In a further aspect of the present invention, there is provided a pump lower unit of a dishwasher having a screen filter installed thereon, the pump lower unit including: a mounting protrusion formed at a predetermined portion of the screen filter for aligning the screen filter on the pump lower unit; and a fastener insert hole for coupling a fastening member that passes through the screen filter to fasten the screen filter to the pump lower unit.

The dishwasher and its screen filter and pump lower unit according to the present invention allows precise alignment of the screen filter with the bottom of the pump lower unit when the two are coupled.

Also, the dishwasher and its screen filter and pump lower unit substantially simplify the assembling process of the screen filter.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view of a dishwasher having a sump according to the present invention;

FIG. 2 is a perspective view of a sump according to the present invention;

FIG. 3 is a sectional view of the sump in FIG. 2 taken along lines I-I′;

FIG. 4 is an exploded perspective view of a sump according to the present invention;

FIG. 5 is a top perspective view of a pump lower unit according to the present invention;

FIG. 6 is a bottom perspective view of the pump lower unit in FIG. 5; and

FIG. 7 is a plan view of a screen filter according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

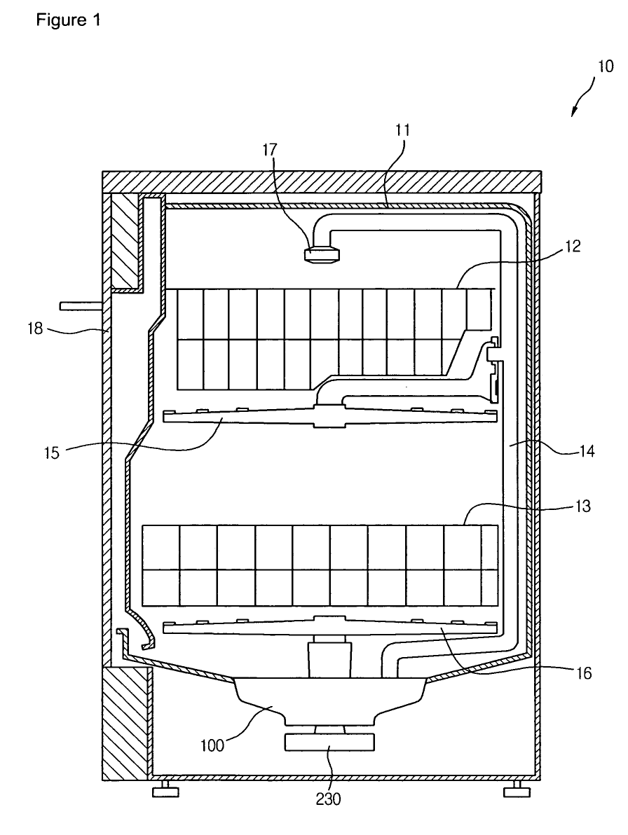

FIG. 1 is a sectional view of a dishwasher having a sump according to the present invention.

Referring to FIG. 1, a dishwasher 10 having a sump according to the present invention includes a tub 11 forming the outer shape of the dishwasher 10 and a wash compartment within, a door 18 formed at the front of the tub 11 for opening and closing the wash compartment, and a sump 100 installed at the central bottom portion of the tub 11 for storing wash liquid inside.

Additionally, the dishwasher 10 includes a wash motor 230 attached at the bottom of the sump 100 for driving a wash pump (not shown) installed inside the sump 100, a water guide 14 forming a passage for wash liquid pumped by the wash pump, a lower spray arm 16 coupled above the sump 100 for spraying wash liquid in an upper and/or lower direction inside the wash compartment, an upper spray arm 15 extending outward to the center of the tub 11 from a point on the water guide 14, and a top nozzle 17 extending from the top end of the water guide 14 at the ceiling of the tub 11 for spraying wash liquid in a downward direction.

The dishwasher 10 also includes an upper rack 12 located directly above the upper spray arm 15, and a lower rack 13 located directly above the lower spray arm 16. Specifically, the dishes stored in the upper rack 12 are washed by wash liquid sprayed from the upper spray arm 15 and the top nozzle 17, and dishes stored in the lower rack 13 are washed by wash liquid sprayed from the lower spray arm 16.

The operation of the dishwasher according to the present invention will now be described.

First a user opens the door 18 of the dishwasher 10, and pulls the upper rack 12 and/or lower rack 13 out from the wash compartment. Then, dishes are loaded onto the dish racks 12 and 13, the door 18 is closed, and a start button is pressed to begin a wash course.

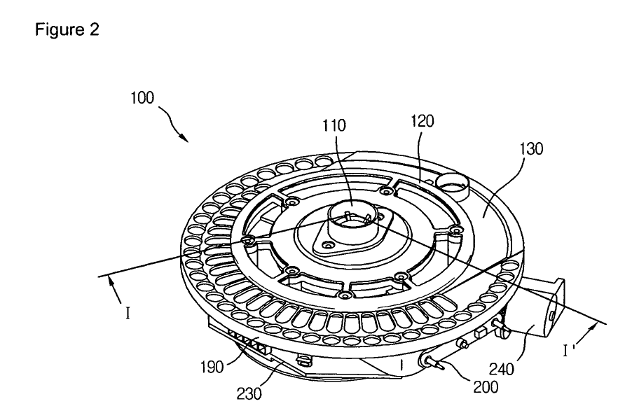

When the start button of the dishwasher 10 is pressed and a wash cycle is begun, wash liquid is supplied to the inside of the sump 100 through an opened water supply valve. After a certain amount of wash liquid enters the sump 100, the wash motor 230 operates. An impeller (150 in FIG. 2), provided inside the wash pump and connected to the shaft of the wash motor 230, rotates to pump wash liquid to the lower spray arm 16 and the water guide 14.

The wash liquid pumped to the water guide 14 flows to the top nozzle 17 and the upper spray arm 15 to be ultimately sprayed therefrom into the wash compartment. The sprayed wash liquid washes the dishes loaded on the racks 12 and 13.

Here, the top nozzle 17 sprays wash liquid vertically downward, and the upper spray arm 15 sprays wash liquid vertically upward, to wash dishes stored in the upper rack 12.

The lower spray arm 16 sprays wash liquid vertically upward to wash dishes stored in the lower rack 13. The upper spray arm 15 may have spray holes formed at the bottom thereof to spray wash liquid in both upward and downward directions in order to wash the top portions of dishes stores in the lower rack 13.

Impurities that are released during the wash cycle are filtered by a filter (not shown) formed on the sump 100, and are ground into small pieces by a disposer installed inside the sump 100. When the wash course is completed, the contaminated wash liquid is discharged to the outside of the dishwasher 10 along with the impurities by means of a drain pump (not shown).

When the wash liquid is discharged to the outside, fresh wash liquid enters into the sump 100 through an intake, whereupon a cycle similar to the wash cycle is performed to spray wash liquid through the spray arms 15 and 16. The thus sprayed fresh wash liquid rinses the dishes in a rinse cycle. When the rinse cycle is finished, a drying cycle is performed to complete the entire wash course.

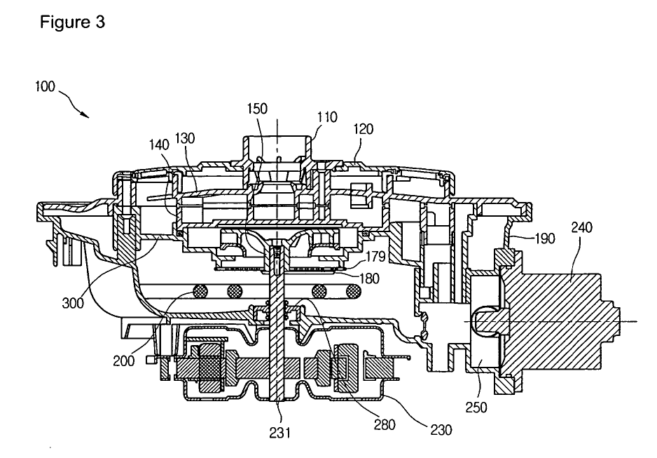

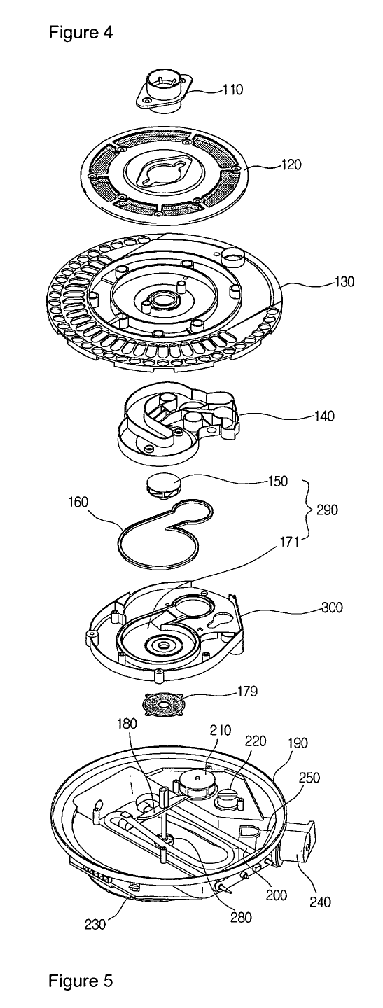

FIG. 2 is a perspective view of a sump according to the present invention, FIG. 3 is a sectional view of the sump in FIG. 2 taken along lines I-I′, and FIG. 4 is an exploded perspective view of a sump according to the present invention.

Referring to FIGS. 2 through 4, the sump 100 according to the present invention includes a sump case 190 being the lowest portion of the sump 100 for storing wash liquid within, a sump cover 130 covering the upper portion of the sump case 190, a self-cleaning filter 120 stepped and mounted a predetermined height upward on the top portion of the sump cover 130, a lower spray arm holder 110 mounted at the central portion of the self-cleaning filter 120 and connected to the lower spray arm 16, a wash motor 230 installed below the sump case 190 for generating rotational force, and a drain pump 250 and a drain motor 240 mounted to the side of the sump case 190 for discharging wash liquid to the outside.

The sump 100 also includes a heater 200 installed on the inner floor of the sump case 190 for heating wash liquid, a disposer 180 connected to a motor shaft 231 of the wash motor 230 to rotate integrally with the motor shaft 231 and grind food particles, a pump lower unit 300 mounted above the sump case 190 and having a soil chamber formed thereon for collecting food particles, a guide passage 140 resting between the sump cover 130 and the pump lower unit 300, a wash pump 290 formed between the pump lower unit 300 and the guide passage 140 for pumping wash liquid, and a screen filter 400 installed between the pump lower unit 300 and the disposer 180 for preventing food particles ground by the disposer 180 from entering the wash pump 290.

In further detail, the screen filter 400 has a plurality of small holes formed thereon to filter food particles, and is attached to the bottom surface of the pump lower unit 300. The wash pump 290 includes a pump case 310 forming the central portion of the pump lower unit 300, and an impeller 150 mounted inside the pump case 310. The impeller 150 is connected to and rotates with the motor shaft 231, and suctions wash liquid into the sump case 190 and discharges wash liquid out from the pump case 310. The guide passage 140 has a passage formed therein for guiding wash liquid pumped by the wash pump 290 at its upper portion to the upper spray arm or the lower spray arm. The passage will be described with below with reference to the diagrams.

The sump 100 includes a vario valve 210 installed at a side of the sump case 190, a turbidity sensor 220 installed proximally to the vario valve 210, and a pump seal 160 that inserts into a groove formed in the top surface of the pump lower unit 300. The vario valve 210 alternately regulates the flow of wash liquid pumped by the wash pump 290 to the upper spray arm and the lower spray arm. The turbidity sensor 220 senses the contamination level of wash liquid collected in the sump 100 during the wash course. The pump seal 160 prevents wash liquid from leaking between the edges of the wash pump 290 and the vario valve 210.

The operation of the sump 100 according to the present invention will now be described.

First, wash liquid enters the inside of the sump case 190 through a water supply device when a wash course is begun. Then, the wash motor 230 operates to rotate the impeller 150. When the impeller 150 rotates, wash liquid enters the pump case 310. The wash liquid that enters the pump case flows toward the vario valve 210. The wash liquid that flows to the vario valve 210 flows to the water guide 14 formed at the top of the guide passage 140 or the lower spray arm holder 110.

A portion of the wash liquid flowing from the wash pump 290 to the vario valve 210 branches towards the turbidity sensor 220 so that the latter can sense the contamination level of the wash liquid. The wash liquid that passes the turbidity sensor 220 flows to the drain pump 250, and the wash liquid collected at the drain pump 250 is discharged to the outside of the dishwasher by the operation of the drain motor 240.

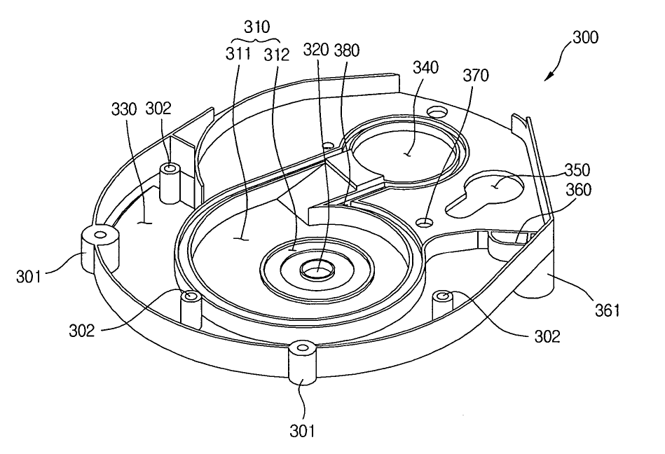

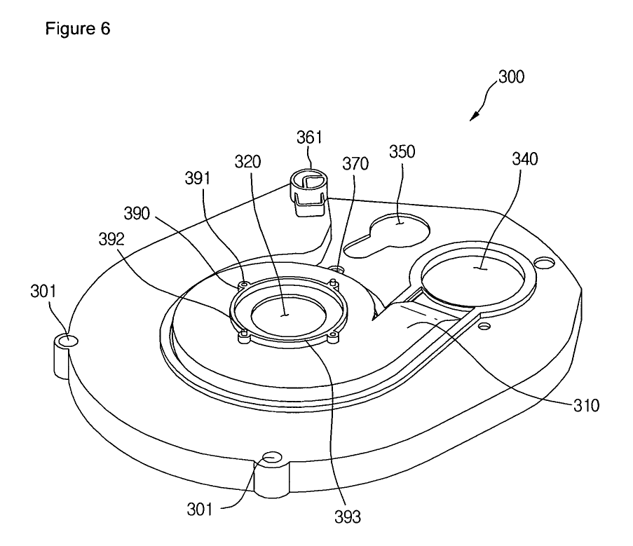

FIG. 5 is a top perspective view of a pump lower unit according to the present invention, and FIG. 6 is a bottom perspective view of the pump lower unit in FIG. 5.

Referring to FIGS. 5 and 6, the pump lower unit 300 according to the present invention is mounted on the top surface of the sump case 190.

In more detail, the pump lower unit 300 includes a sump case mounting hole 301, a self-cleaning filter mounting hole 302, a pump case 310, a wash liquid intake hole 320, a soil chamber 330, a vario valve seat 340, a turbidity sensor seat 350, a drain pump connecting duct 360, a water drain hole 370, and a pump seal insert groove 380.

The sump case mounting hole 301 is formed on the outer edge of the pump lower unit 300, and couples the self-cleaning filter 120 and the sump case 190 together. The self-cleaning filter mounting hole 302 is formed to protrude at predetermined intervals from the inner surface of the sump case 190, and couples to the self-cleaning filter 120. The wash liquid intake hole 320 is formed at roughly the center of the pump lower unit 300, for wash liquid to be suctioned through by means of the rotating impeller 150.

The pump case 310 has a recessed impeller seat 312 for seating the impeller 150 on and a pumping passage 311 for centrifugally rotating the wash liquid suctioned by the impeller 150. Here, the connecting portion from the end of the pumping passage 311 to the vario valve seat 340 is inclined at a predetermined angle, so that wash liquid flows evenly to the vario valve 210.

The turbidity sensor seat 350 for inserting the turbidity sensor 220 is disposed proximally to the vario valve seat 340. The drain pump connecting duct 360 is formed at a location separated a predetermined distance from the turbidity sensor seat 350, so that wash liquid that passes the turbidity sensor 220 can fall into the drain pump 250. A drain pump connecting pipe 361 is formed to extend a predetermined distance from below the drain pump connecting duct 360. The drain pump connecting pipe 361 is connected to the interior of the drain pump 250.

The water drain hole 370 is formed between the pump case 310 and the turbidity sensor seat 350. Wash water that falls through a water drain hole 147 of the guide passage 140 enters the sump case 190 through the water drain hole 370.

The sump seal insert groove 380 is formed along the outer edges of the pump case 310 and the vario valve seat 340. The pump seal 160 is mounted in the pump seal insert groove 380.

The soil chamber 330 is a portion in which wash liquid flows in a reverse direction after it enters the drain pump 250 by flowing down through the drain pump connecting duct 360 and the drain pump connecting pipe 361. Specifically, the soil chamber 330 is formed to have a predetermined curvature along the outer portion of the pump lower unit 300. Impurities in wash liquid that passes the turbidity sensor 220 accumulate on the floor of the soil chamber 330. The accumulated impurities enter the drain pump 250 and are discharged to the outside during the draining process.

A structure for mounting the screen filter 400 is formed on the rear surface of the pump lower unit 300. The screen filter 400 mounting structure includes a screen filter mounting knob 390, a mounting protrusion 292, a fastener insert hole 391, and a mounting sleeve 393.

In further detail, the screen filter mounting knob 390 protrudes a predetermined distance from the edge of the wash liquid intake hole 320 at the rear of the sump case 310. The screen filter mounting knob 390 has a fastener insert hole 391 formed therein for a fastener that fastens the screen filter 400 to insert into.

The mounting protrusion 392 protrudes a predetermined distance from the edge of the wash liquid intake hole 320, and is spaced a predetermined distance from screen filter mounting knob 390. The mounting protrusion 392 protrudes a predetermined distance further than the screen filter mounting knob 390. A predetermined portion of the screen filter 400 mounts to the mounting protrusion, and the coupling location of the screen filter 400 is aligned, which will be described below.

The mounting sleeve 393 is formed in a protruding ring around the wash liquid intake port 320 at the rear of the pump case 310. The mounting sleeve 393 has a diameter that is approximately the same in size as the outer diameter of the screen filter 400, and the screen filter 400 is mounted therein. The screen filter mounting knob 390 and the mounting protrusion 392 are formed on the outer circumference of the mounting sleeve 393.

Here, at least two the mounting protrusions 392 are formed, and prevent the screen filter 400 from moving after it is mounted. Each mounting protrusion 392 may be formed in mutually-facing locations. Similarly, the screen filter mounting knob 390 may be formed in mutually-opposite locations. However, the number of mounting protrusions 392 and the screen filter mounting knobs 390 and their respective locations are not restricted to this embodiment.

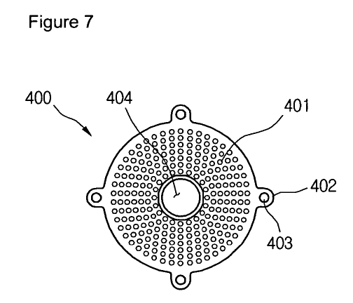

FIG. 7 is a plan view of a screen filter according to the present invention.

Referring to FIG. 7, the screen filter 400 according o the present invention is mounted on the mounting sleeve 393 formed at the bottom of the pump lower unit 300.

In further detail, the screen filter 400 filters impurities in wash liquid that enters through the wash liquid intake hole 320 in a primary filtering stage. Thus, the screen filter has a plurality of filtering holes 401 with a small diameter formed within.

Also, the outer perimeter of the screen filter 400 has a mounting knob 402 protruding therefrom. The protruding knob 402 may be provided in a plurality spaced a predetermined distance apart from one another. An insert hole 403 is formed in the mounting knob 402 for inserting a fastening member therethrough, such as the mounting protrusion 392 or a bolt. The motor shaft 231 passes through a motor shaft insert hole 404 formed in the central portion of the screen filter 400.

The screen filter 400 may be formed of a rigid board so that it is not suctioned into the pump case 310 by the pressure of the wash liquid suctioned by the wash pump 290.

A description will now be given of the installation process of the above-structured screen filter 400 to the pump lower unit 300.

First, the screen filter is mounted to the mounting sleeve 393.

Next, the mounting protrusion 392 is inserted into the insert hole 403 of the screen filter 400, thus properly aligning the screen filter 400. Here, the other insert holes 403 of the screen filter are aligned with the fastener insert holes 391 formed on the screen filter mounting knobs 390.

Subsequently, a fastening member is coupled to the fastener insert hole, fixing the screen filter 400 to the pump lower unit 300.

A description of the flow of wash liquid within the pump lower unit 300 with the attached screen filter 400 will now be given.

First, impurities in wash liquid suctioned through the rotation of the impeller 150 are removed by the screen filter 400 in a first filtering stage. Then, the wash liquid that is filtered of impurities enters the pump case 310. The wash liquid that enters the pump case 310 flows along the pumping passage 311 to the vario valve 210. As described above, the wash liquid then passes the turbidity sensor 220 and enters the drain pump 250, after which it backs up. The backing up wash liquid flows into the soil chamber 330. The wash liquid that flows into the soil chamber 330 is filtered by the mesh filter 128 of the self-cleaning filter 120, and flows back into the bottom of the tub. The flowing back wash liquid flows through a return hole of the sump cover 130 and returns into the sump case 190. The food deposits collected in the soil chamber 330 are discharged to the outside by the drain pump 250 in the draining process.

The above-structured dishwasher and its screen filter and pump lower unit allows a precise positioning of the screen filter on the pump lower unit when the two components are coupled.

Also, the dishwasher and its screen filter and pump lower unit substantially simplify the assembling process of the screen filter.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A dishwasher comprising:
a pump lower unit;
a screen filter installed on the pump lower unit for removing impurities from wash liquid;
a mounting protrusion and an insert hole for aligning the screen filter with the pump lower unit; and
a mounting knob for coupling a fastening member for fastening the screen filter to the pump lower unit.

2. The dishwasher according to claim 1, wherein the mounting protrusion is formed on the pump lower unit, and the insert hole is formed on the screen filter.

3. The dishwasher according to claim 2, wherein the insert hole is formed on an outer perimeter of the screen filter.

4. The dishwasher according to claim 1, wherein the mounting protrusion protrudes a predetermined distance higher than the mounting knob.

5. The dishwasher according to claim 1, wherein the mounting protrusion is provided in plurality, and the plurality of mounting protrusions are separated from each other by a predetermined distance.

6. The dishwasher according to claim 5, wherein the mounting protrusions are positioned opposite one another across a central portion of the screen filter.

7. The dishwasher according to claim 1, wherein the mounting knob has a hole formed therein for inserting the fastening member.

8. The dishwasher according to claim 1, wherein the mounting knob is formed on the pump lower unit opposite to an outer perimeter of the screen filter.

9. The dishwasher according to claim 1, wherein the mounting knob is provided in plurality, and the plurality of mounting knobs are separated from each other by a predetermined distance.

10. The dishwasher according to claim 9, wherein the mounting knobs are positioned opposite one another across a central portion of the screen filter.

11. The dishwasher according to claim 1, wherein the pump lower unit includes a mounting sleeve formed thereon for mounting the screen filter.

12. The dishwasher according to claim 1, wherein the screen filter is rigid board.

13. The dishwasher according to claim 1, wherein the screen filter includes a hole formed therein for a motor shaft to pass through.

14. A screen filter installed on a pump lower unit of a dishwasher for removing impurities from wash liquid, the screen filter comprising:
an aligning hole formed in a predetermined portion of the pump lower unit for aligning the screen filter on the pump lower unit; and
a through-hole for fastening the screen filter to the pump lower unit by means of a fastening member passing through the through-hole.

15. The screen filter according to claim 14, further comprising two or more mounting knobs projecting a predetermined distance from an outer periphery of the screen filter, wherein the aligning hole and through-hole are formed in the mounting knob.

16. The screen filter according to claim 14, wherein the screen filter is a rigid board.

17. The screen filter according to claim 14, further comprising a motor shaft insert hole through which a motor shaft passes.

18. A pump lower unit of a dishwasher having a screen filter installed thereon, the pump lower unit comprising: a mounting protrusion formed at a predetermined portion of the screen filter for aligning the screen filter on the pump lower unit; and
a fastener insert hole for coupling a fastening member that
passes through the screen filter to fasten the screen filter to the pump lower unit.

19. The pump lower unit according to claim 18, further comprising a mounting sleeve formed thereon for mounting the screen filter on the pump lower unit.

20. The pump lower unit according to claim 19, wherein the mounting protrusion and the fastener insert hole are formed on the mounting sleeve.
